(19) United States
(12) Patent Application Publication
(10) Pub. No.: US 2026/0113696 A1
(43) Pub. Date: Apr. 23, 2026

(54) SYSTEMS AND METHODS FOR SELECTING A CONCEALED IDENTIFIER FOR A FIFTH GENERATION STANDALONE CAPABLE DEVICE

(71) Applicant: Verizon Patent and Licensing inc., Basking Ridge, NJ (US)

(72) Inventors: Shanthala KURAVANGI-THAMMAIAH, Keller, TX (US); Samirkumar PATEL, Middlesex, NJ (US); Lalit R. KOTECHA, San Ramon, CA (US); Axel HALLO DE WOLF, Whippany, NJ (US)

(73) Assignee: Verizon Patent and Licensing Inc., Basking Ridge, NJ (US)

(21) Appl. No.: 18/919,705

(22) Filed: Oct. 18, 2024

(51) Int. Cl. H04W 48/18; H04W 8/20; H04W 12/06

(52) U.S. Cl. CPC H04W 48/18; H04W 8/205; H04W 12/06

(57) ABSTRACT

A device may receive, from a user equipment (UE) and regardless of radio access technologies utilized, a core network attach request with a concealed subscriber identifier, and may provide the core network attach request with the concealed subscriber identifier to a core network. The device may receive an authorization success message from the core network, and may provide the authorization success message to the UE. The device may enable, based on the authorization success message, the UE to attach to the core network via an untrusted access network.

### BACKGROUND

In the field of telecommunications, subscriber identities need to be managed effectively as user equipments (UEs) access services through various radio access technologies (RATs), such as Wi-Fi and cellular networks, to maintain proper service provisioning and accounting.

### BRIEF DESCRIPTION OF THE DRAWINGS

FIGS. 1A-1E are diagrams of an example associated with selecting an identifier for a fifth generation (5G) standalone (SA) capable device.

FIG. 2 is a diagram of an example environment in which systems and/or methods described herein may be implemented.

FIG. 3 is a diagram of another example environment in which systems and/or methods described herein may be implemented.

FIG. 4 is a diagram of example components of one or more devices of FIGS. 2 and 3.

FIG. 5 is a flowchart of an example process for selecting an identifier for a 5G SA capable device.

### DETAILED DESCRIPTION OF EXAMPLE EMBODIMENTS

The following detailed description of example implementations refers to the accompanying drawings. The same reference numbers in different drawings may identify the same or similar elements.

Challenges arise in managing subscriber identities because 5G SA capable UEs may be associated with either a fourth generation (4G) provisioning plan or a 5G provisioning plan. UEs currently lack the capability to recognize the distinction between these provisioning plans, particularly when accessing services via untrusted non-3rd Generation Partnership Project (3GPP) access networks (e.g., Wi-Fi networks). In such scenarios, these 5G SA capable UEs default to utilizing an international mobile subscriber identity (IMSI) for authentication purposes during non-seamless wireless offload (NSWO) situations, regardless of whether the UEs regularly attach to a 4G core network or a 5G core network. This practice undermines privacy advantages intrinsic to the 5G core network, where a subscription concealed identifier (SUCI) may be utilized for enhanced privacy. Thus, current techniques for managing subscriber identities consume computing resources (e.g., processing resources, memory resources, communication resources, and/or the like), networking resources, and/or other resources associated with 5G SA capable UEs failing to select SUCI for authentication when provisioned with a 5G provisioning plan, or conversely selecting IMSI when provisioned with a 4G provisioning plan during non-3GPP access, failing to uphold intended privacy standards of a 5G core network, adding complexity and inefficiency to network operations, failing to maintain subscriber identities, and/or the like.

Some implementations described herein relate to a device that selects an identifier for a 5G SA capable device. For example, a device (e.g., an ePDG) may receive, from a UE and regardless of radio access technologies (RATs) utilized, a core network attach request with a concealed subscriber identifier, and may provide the core network attach request with the concealed subscriber identifier to a 5G core network. The ePDG may receive an authorization success message from the 5G core network, and may provide the authorization success message to the UE. The ePDG may enable, based on the authorization success message, the UE to attach to the 5G core network via an untrusted access network. Alternatively, the ePDG may receive, from the 5G core network, an authorization reject message with an error code indicating that the UE is not authorized to attach to the 5G core network, and may store the error code. The ePDG may provide the authorization reject message with the error code to the UE, and may prevent, based on the authorization reject message, the UE from attaching to the 5G core network via the untrusted access network.

In this way, the ePDG may select an identifier for a 5G SA capable device. For example, the ePDG may enhance subscriber identity management in telecommunications by distinguishing between 4G and 5G provisioning plans in non-3GPP access scenarios. The ePDG may handle core network attach requests that incorporate enhanced privacy features by utilizing both concealed subscriber identifiers (e.g., SUCIs) and traditional unconcealed subscriber identifiers (e.g., IMSIs). Additionally, the ePDG may receive and store error codes from the core network when an attachment is unauthorized, and may utilize these stored error codes to optimize future UE attachment procedures. Moreover, the ePDG may process an indication from the UE reflecting provisioning for a particular core network, enabling the ePDG to present an appropriate subscriber identifier to facilitate accurate network attachment. A flag received from the UE may enable the ePDG to differentiate between a UE provisioned for a 5G core network and for a 4G core network. Thus, the ePDG may conserve computing resources, networking resources, and/or other resources that would have otherwise been consumed by 5G SA capable UEs failing to select SUCI for authentication when provisioned with a 5G provisioning plan, or conversely to select IMSI when provisioned with a 4G provisioning plan during non-3GPP access, failing to uphold intended privacy standards of a 5G core network, adding complexity and inefficiency to network operations, failing to maintain subscriber identities, and/or the like.

The prioritization of SUCIs for UEs with 5G provisioning plans while maintaining IMSIs for UEs with 4G provisioning plans may considerably decrease incorrect network attachment trials, reducing congestion and additional load on the core networks. The ePDG may reduce the likelihood of attachment errors and may streamline the identity verification process in line with applicable privacy constraints.

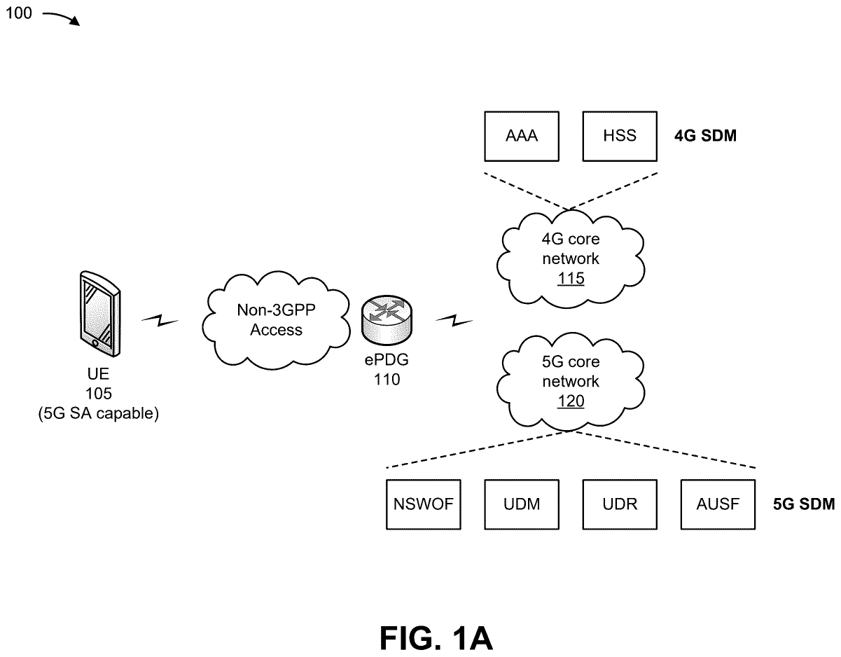

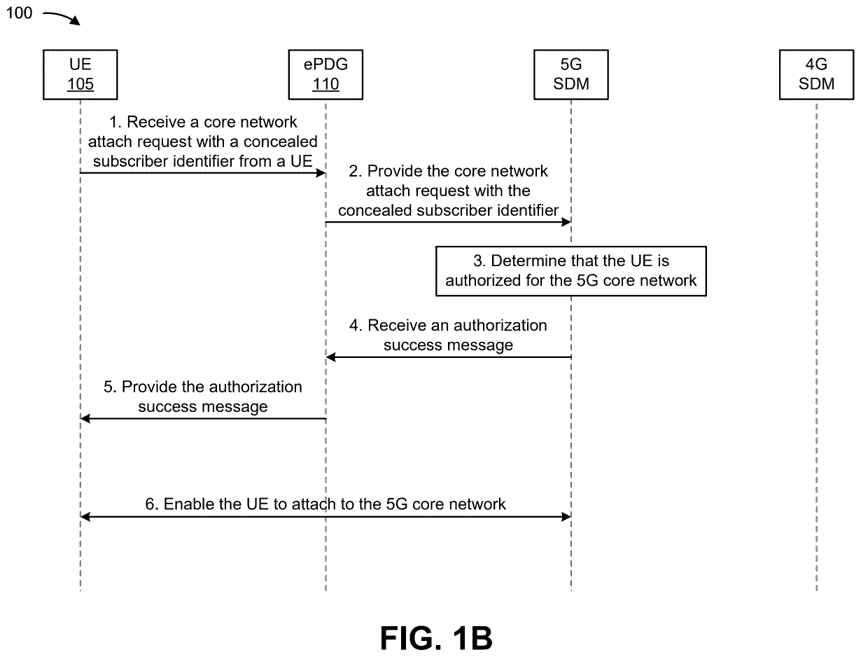

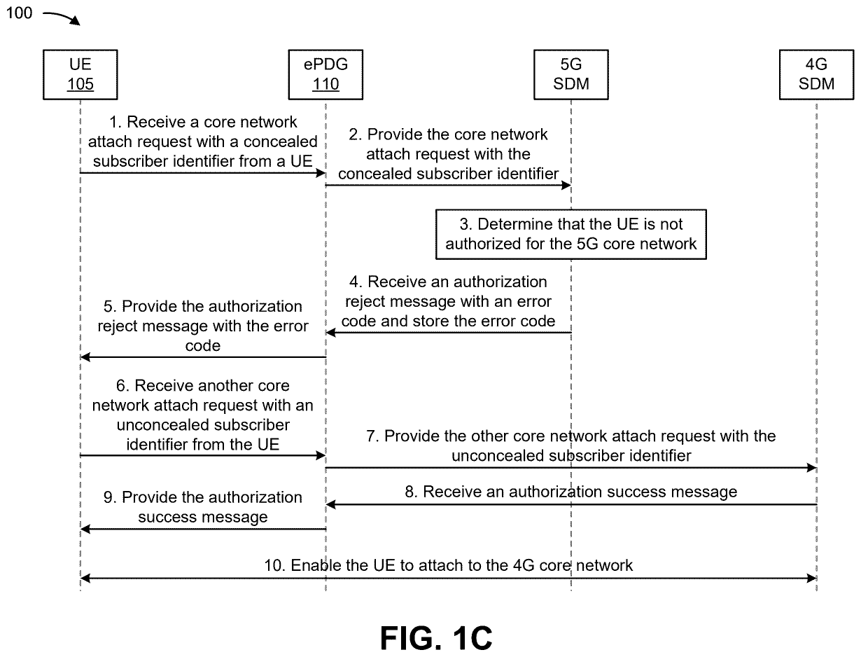

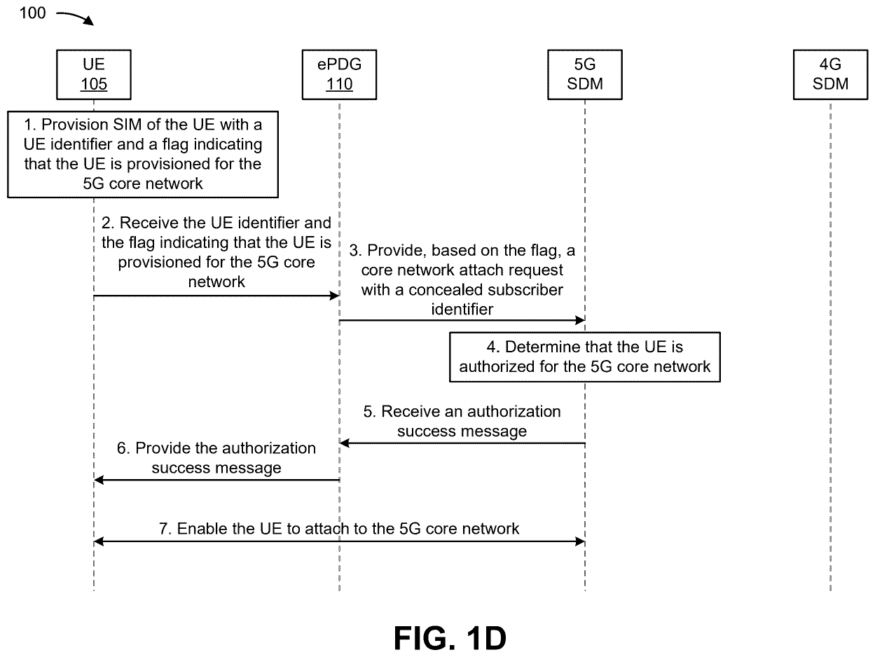

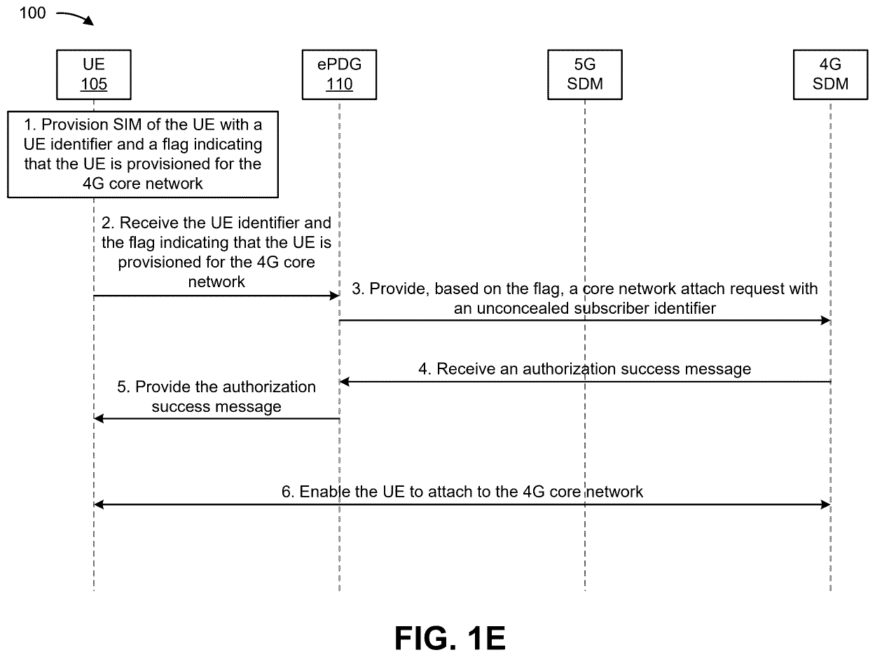

FIGS. 1A-1E are diagrams of an example 100 associated with selecting a concealed identifier for a 5G SA capable device. As shown in FIG. 1A, the example 100 includes a UE 105 associated with a non-3GPP access network, an evolved packet data gateway (ePDG) 110, a 4G core network 115, and a 5G core network 120. The 4G core network 115 may include 4G subscriber data management (SDM) devices, such as an authentication, authorization, and accounting server (AAA) and a home subscriber server (HSS). The 5G core network 120 may include 5G SDM devices, such as a non-seamless wireless local area network (WLAN) offload function (NSWOF), a unified data management (UDM) component, a unified data repository (UDR), and an authentication server function (AUSF). Further details of the UE 105, the non-3GPP access network, the ePDG 110, the 4G core network 115, the 5G core network 120, the AAA, the HSS, the NSWOF, the UDM, the UDR, and the AUSF are provided elsewhere herein.

FIG. 1B depicts an example information flow diagram associated with enabling the UE 105 to attach to the 5G core network 120 via the non-3GPP access network. As shown at step 1 of FIG. 1B, the ePDG 110 may receive a core network attach request with a concealed subscriber identifier from the UE 105. For example, the UE 105 may generate the core network attach request that includes an SUCI associated with a subscriber of the UE 105 when the UE 105 is configured with a 5G provisioning plan. The UE 105 may provide the core network attach request to the ePDG 110, and the ePDG 110 may receive the core network attach request. In some implementations, the core network attach request may include the SUCI (e.g., an encrypted subscriber identifier) to ensure that the subscriber identifier is protected during transmission to safeguard user privacy. This may prevent unauthorized entities from identifying the UE 105 based on the subscriber identifier. The encryption may further enhance the security of the subscriber information by making it accessible only to authorized components within the 5G core network 120.

As shown at step 2 of FIG. 1B, the ePDG 110 may provide the core network attach request with the concealed subscriber identifier to a 5G SDM device (e.g., one or more of the NSWOF, the UDM, the UDR, and the AUSF). For example, the ePDG 110 may provide the core network attach request with the concealed subscriber identifier to one or more of the NSWOF, the UDM, the UDR, and the AUSF. In some implementations, the ePDG 110 may forward the subscriber concealed identifier along with the core network attach request to relevant 5G SDM components to ensure that the attach request reaches a correct entity for authorization checks. Additionally, or alternatively, the ePDG 110 may provide the concealed subscriber identifier to a specified 5G SDM entity for validation. The validation process may verify the authenticity of the subscriber and the attach request.

As shown at step 3 of FIG. 1B, the 5G SDM device may determine that the UE 105 is authorized for the 5G core network 120. For example, the 5G SDM device may verify an authorization status of the UE 105 against subscriber data records. This verification may ensure that only authorized subscribers gain access to the 5G core network 120. Additionally, or alternatively, based on stored subscription information, the 5G SDM device may validate that the UE 105 is permitted to access the 5G core network 120.

As shown at step 4 of FIG. 1B, the ePDG 110 may receive an authorization success message from the 5G SDM device. For example, the 5G SDM may generate the authorization success message based on determining that the UE 105 is authorized for the 5G core network 120. The 5G SDM device may provide the authorization success message to the ePDG 110, and the ePDG 110 may receive the authorization success message. In some implementations, the authorization success message may provide confirmation that the UE 105 is permitted to attach to the 5G core network 120. Additionally, or alternatively, the authorization success message may enable the ePDG 110 to proceed to next steps required for network attachment of the UE 105.

As shown at step 5 of FIG. 1B, the ePDG 110 may provide the authorization success message to the UE 105. As further shown in FIG. 1B, the ePDG 110 may forward the authorization success message to the UE 105, and the UE 105 may receive the authorization success message. The authorization success message may enable the UE 105 determine that network attachment has been authorized for the 5G core network 120, and that the UE 105 may proceed with initiating a network connection.

As shown at step 6 of FIG. 1B, the ePDG 110 and the 5G SDM device may enable the UE 105 to attach to the 5G core network 120 via the non-3GPP access network. For example, the ePDG 110, in conjunction with the 5G SDM device, may facilitate a seamless network attachment of the UE 105 through the non-3GPP access network and to the 5G core network 120. In some implementations, the approved UE 105 may attach to the 5G core network 120 via the ePDG 110, the 5G SDM device, and the non-3GPP access network.

FIG. 1C depicts an example information flow diagram associated with preventing the UE 105 from attaching to the 5G core network 120 via the non-3GPP access network. As shown at step 1 of FIG. 1C, the ePDG 110 may receive a core network attach request with a concealed subscriber identifier from the UE 105. For example, the UE 105 may generate the core network attach request that includes a SUCI associated with a subscriber of the UE 105 when the UE 105 is configured with a 5G provisioning plan. The UE 105 may provide the core network attach request to the ePDG 110, and the ePDG 110 may receive the core network attach request. In some implementations, the core network attach request may include the SUCI (e.g., an encrypted subscriber identifier) to ensure that the subscriber identifier is protected during transmission to safeguard user privacy. This may prevent unauthorized entities from identifying the UE 105 based on the subscriber identifier. The encryption may further enhance the security of the subscriber information by making it accessible only to authorized components within the 5G core network 120.

As shown at step 2 of FIG. 1C, the ePDG 110 may provide the core network attach request with the concealed subscriber identifier to a 5G SDM device (e.g., one or more of the NSWOF, the UDM, the UDR, and the AUSF). For example, the ePDG 110 may provide the core network attach request with the concealed subscriber identifier to one or more of the NSWOF, the UDM, the UDR, and the AUSF. In some implementations, the ePDG 110 may forward the subscriber concealed identifier along with the core network attach request to relevant 5G SDM components to ensure that the attach request reaches a correct entity for authorization checks. Additionally, or alternatively, the ePDG 110 may provide the concealed subscriber identifier to a specified 5G SDM entity for validation. The validation process may verify the authenticity of the subscriber and the attach request.

As shown at step 3 of FIG. 1C, the 5G SDM device may determine that the UE 105 is not authorized for the 5G core network 120. For example, the 5G SDM device may verify an authorization status of the UE 105 against subscriber data. This verification may ensure that only authorized subscribers gain access to the 5G core network 120. In some implementations, the 5G SDM device may determine that the UE 105 lacks the necessary authorization to access the 5G core network 120 based on the verification. For example, the 5G SDM device may check subscription details and may determine that the UE 105 does not qualify (e.g., is ineligible) for access to the 5G core network 120 based on the check.

As shown at step 4 of FIG. 1C, the ePDG 110 may receive, from the 5G SDM device, an authorization reject message with an error code and may store the error code. For example, based on determining that the UE 105 is not authorized for access to the 5G core network 120, the 5G SDM device may generate the authorization reject message with the error code. The 5G SDM device may provide the authorization reject message with the error code to the ePDG 110, and the ePDG 110 may receive the authorization reject message and may store the error code. In some implementations, the error code may specify that the UE 105 is not authorized due to a provisioning plan, prompting the ePDG 110 to store the error code for future reference. This may aid in optimizing the handling of future attach requests from the UE 105.

As shown at step 5 of FIG. 1C, the ePDG 110 may provide the authorization reject message with the error code to the UE 105. For example, the ePDG 110 may forward the authorization reject message with the error code to the UE 105, and the UE 105 may receive the authorization reject message. Based on the authorization reject message, the UE 105 may be informed that the UE 105 is not authorized to attach to the 5G core network 120, and may proceed with alternative actions for network attachment.

As shown at step 6 of FIG. 1C, the ePDG 110 may receive another core network attach request with an unconcealed subscriber identifier from the UE 105. For example, upon receiving the authorization reject message indicating failure for 5G attachment, the UE 105 may generate and provide, to the ePDG 110, another core network attach request with an unconcealed subscriber identifier (e.g., an IMSI). The ePDG 110 may then receive this new core network attach request with the IMSI from the UE 105.

As shown at step 7 of FIG. 1C, the ePDG 110 may provide the other core network attach request with the unconcealed subscriber identifier to a 4G SDM device (e.g., one or more of the AAA and the HSS). For example, the ePDG 110 may forward the other core network attach request with the unconcealed subscriber identifier (e.g., the IMSI) to an appropriate 4G SDM device of the 4G core network 115 for authorization. In some implementations, the ePDG 110 may ensure that the other core network attach request directed towards the 4G core network 115 is handled by the AAA and/or the HSS. This may ensure that the other core network attach request is processed by the relevant 4G network components.

As shown at step 8 of FIG. 1C, the ePDG 110 may receive an authorization success message from the 4G SDM device. For example, upon successful verification and authorization, the 4G SDM device may generate and provide the authorization success message to the ePDG 110. The ePDG 110 may receive authorization success message verifying that the UE 105 is permitted to attach to the 4G core network 115.

As shown at step 9 of FIG. 1C, the ePDG 110 may provide the authorization success message to the UE 105. For example, the ePDG 110 may forward the authorization success message to the UE 105, and the UE 105 may receive the authorization success message. This message confirms to the UE 105 that the UE 105 may proceed with attaching to the 4G core network 115, facilitating the connection process. In some implementations, the authorization success message may initiate the attachment process for the UE 105.

As shown at step 10 of FIG. 1C, the ePDG 110 and the 4G SDM device may enable the UE 105 to attach to the 4G core network 115 via the non-3GPP access network. For example, the ePDG 110, in conjunction with the 4G SDM device, may facilitate a seamless network attachment of the UE 105 to the 4G core network 115, via the non-3GPP access network. In some implementations, the UE 105 may attach to the 4G core network 115, via the non-3GPP access network, with guidance and authorization from the ePDG 110 and the 4G SDM device.

FIG. 1D depicts an example information flow diagram associated with enabling the UE 105 to attach to the 5G core network 120 via the non-3GPP access network. As shown at step 1 of FIG. 1D, a subscriber identity module (SIM) of the UE 105 may be provisioned with a UE identifier (e.g., concealed or not concealed) and a flag indicating that the UE 105 is provisioned for the 5G core network 120. For example, the SIM of the UE 105 may be configured by a network operator to include a flag that specifies that the UE 105 is subscribed to a 5G provisioning plan. The flag may enable the UE 105 to recognize that the UE 105 is provisioned for the 5G core network 120. In some implementations, provisioning the SIM of the UE 105 with the flag may include pushing a software update to the UE 105, and configuring the UE 105 to recognize a subscription to the 5G core network 120. For example, a network operator may deploy an over-the-air update to install the software on the SIM of the UE 105, eliminating a need for manual SIM configuration. Additionally, or alternatively, provisioning the SIM of the UE 105 may include storing the flag indicating 5G provisioning in a cloud database, and the UE 105 accessing the cloud database when attempting to connect to a core network 115 or 120.

As shown at step 2 of FIG. 1D, the ePDG 110 may receive the UE identifier and the flag indicating that the UE 105 is provisioned for the 5G core network 120. For example, when the UE 105 attempts to connect to a core network 115 or 120, the ePDG 110 may receive the flag from the SIM of the UE 105. In some implementations, the ePDG 110 may receive the flag from provisioning information provided by a server device, bypassing a need for provisioning the flag in the SIM of the UE 105. For instance, the ePDG 110 may query a centralized database to retrieve a provisioning status of the UE 105, thereby streamlining the connection setup process.

As shown at step 3 of FIG. 1D, the ePDG 110 may provide, to the 5G SDM device and based on the flag, a core network attach request with a concealed subscriber identifier. For example, upon receiving the flag, the ePDG 110 may generate the core network attach request and may include the concealed subscriber identifier (e.g., a SUCI) in the core network attach request. The ePDG 110 may provide the core network attach request with the SUCI to the 5G SDM device (e.g., one or more of the NSWOF, the UDM, the UDR, and the AUSF). This may ensure that appropriate privacy measures are maintained by using the concealed identifier for the subscriber. In some implementations, providing the core network attach request may include using an encrypted version of the SUCI to maintain privacy.

As shown at step 4 of FIG. 1D, the 5G SDM device may determine that the UE 105 is authorized for the 5G core network 120. For example, the 5G SDM device may verify an authorization status of the UE 105 against subscriber data records. This verification may ensure that only authorized subscribers gain access to the 5G core network 120. Additionally, or alternatively, based on stored subscription information, the 5G SDM device may validate that the UE 105 is permitted to access the 5G core network 120. When the validation is successful, the 5G SDM device may proceed with authorization of the UE 105 for access to the 5G core network 120.

As shown at step 5 of FIG. 1D, the ePDG 110 may receive an authorization success message from the 5G SDM device. For example, the 5G SDM device may generate the authorization success message based on determining that the UE 105 is authorized to access the 5G core network 120. The authorization success message may indicate that the UE 105 is authorized to access the 5G core network 120. The 5G SDM device may provide the authorization success message to the ePDG 110, and the ePDG 110 may receive the authorization success message. In some implementations, the ePDG 110 may receive the authorization success message through an intermediate authentication server rather than directly from the 5G SDM device.

As shown at step 6 of FIG. 1D, the ePDG 110 may provide the authorization success message to the UE 105. For example, the ePDG 110 may forward the received authorization success message to the UE 105, thereby informing the UE 105 of the successful authorization for attaching to the 5G core network 120. In some implementations, the 5G SDM device may provide the authorization success message directly to the UE 105 and without utilizing the ePDG 110, which may reduce intermediate steps in the process.

As shown at step 7 of FIG. 1D, the ePDG 110 and the 5G SDM device may enable the UE 105 to attach to the 5G core network 120 via the non-3GPP access network. For example, the ePDG 110, in conjunction with the 5G SDM device, may facilitate a seamless network attachment of the UE 105 through the non-3GPP access network and to the 5G core network 120. In some implementations, the approved UE 105 may attach to the 5G core network 120 via the ePDG 110, the 5G SDM device, and the non-3GPP access network. In some implementations, the ePDG 110 and the 5G SDM device may establish a secure tunnel for securely transporting data packets between the UE 105 and the 5G core network 120, ensuring data integrity and confidentiality.

FIG. 1E depicts an example information flow diagram associated with preventing the UE 105 from attaching to the 5G core network 120 via the non-3GPP access network. As shown at step 1 of FIG. 1E, a SIM of the UE 105 may be provisioned with a UE identifier and a flag indicating that the UE 105 is provisioned for the 4G core network 115. For example, the SIM of the UE 105 may be configured by a network operator to include a flag that specifies that the UE 105 is subscribed to a 4G provisioning plan. The flag may enable the UE 105 to recognize that the UE 105 is provisioned for the 4G core network 115. In some implementations, provisioning the SIM of the UE 105 with the flag may include pushing a software update to the UE 105, and configuring the UE 105 to recognize a subscription to the 4G core network 115. For example, a network operator may deploy an over-the-air update to install the software on the SIM of the UE 105, eliminating a need for manual SIM configuration. Additionally, or alternatively, provisioning the SIM of the UE 105 may include storing the flag indicating 4G provisioning in a cloud database, and the UE 105 accessing the cloud database when attempting to connect to a core network 115 or 120.

As shown at step 2 of FIG. 1E, the ePDG 110 may receive the UE identifier and the flag indicating that the UE 105 is provisioned for the 4G core network 115. For example, when the UE 105 attempts to connect to a core network 115 or 120, the ePDG 110 may receive the flag from the SIM of the UE 105. In some implementations, the ePDG 110 may receive the flag from provisioning information provided by a server device, bypassing a need for provisioning the flag in the SIM of the UE 105. For instance, the ePDG 110 may query a centralized database to retrieve a provisioning status of the UE 105, thereby streamlining the connection setup process.

As shown at step 3 of FIG. 1E, the ePDG 110 may provide, to the 4G SDM device and based on the flag, a core network attach request with an unconcealed subscriber identifier. For example, upon receiving the flag, the ePDG 110 may generate the core network attach request and may include the unconcealed subscriber identifier (e.g., an IMSI) in the core network attach request. The ePDG 110 may provide the core network attach request with the IMSI to the 4G SDM device (e.g., one or more of the AAA and the HSS). This may ensure that appropriate privacy measures are maintained by using the concealed identifier for the subscriber.

As shown at step 4 of FIG. 1E, the ePDG 110 may receive an authorization success message from the 4G SDM device. For example, the 4G SDM device may generate the authorization success message based on determining that the UE 105 is authorized to access the 4G core network 115. The authorization success message may indicate that the UE 105 is authorized to access the 4G core network 115. The 4G SDM device may provide the authorization success message to the ePDG 110, and the ePDG 110 may receive the authorization success message. In some implementations, the ePDG 110 may receive the authorization success message through an intermediate authentication server rather than directly from the 4G SDM device.

As shown at step 5 of FIG. 1E, the ePDG 110 may provide the authorization success message to the UE 105. For example, the ePDG 110 may forward the received authorization success message to the UE 105, thereby informing the UE 105 of the successful authorization for attaching to the 4G core network 115. In some implementations, the 4G SDM device may provide the authorization success message directly to the UE 105 and without utilizing the ePDG 110, which may reduce intermediate steps in the process.

As shown at step 6 of FIG. 1E, the ePDG 110 and the 4G SDM device may enable the UE 105 to attach to the 4G core network 115 via the non-3GPP access network. For example, the ePDG 110, in conjunction with the 4G SDM device, may facilitate a seamless network attachment of the UE 105 to the 4G core network 115, via the non-3GPP access network. In some implementations, the UE 105 may attach to the 4G core network 115, via the non-3GPP access network, with guidance and authorization from the ePDG 110 and the 4G SDM device.

In this way, the ePDG 110 may select an identifier for a 5G SA capable device. For example, the ePDG 110 may enhance subscriber identity management in telecommunications by distinguishing between 4G and 5G provisioning plans in non-3GPP access scenarios. The ePDG 110 may handle core network attach requests that incorporate enhanced privacy features by utilizing both concealed subscriber identifiers and traditional unconcealed subscriber identifiers. Additionally, the ePDG 110 may receive and store error codes from the core network when an attachment is unauthorized, and may utilize these stored error codes to optimize future UE 105 attachment procedures. Moreover, the ePDG 110 may process an indication from the UE 105 reflecting a provision for a particular core network, enabling the ePDG 110 to present an appropriate subscriber identifier to facilitate accurate network attachment. A flag received from the UE 105 may enable the ePDG 110 to differentiate between a UE 105 provisioned for a 5G core network and for a 4G core network. Thus, the ePDG 110 may conserve computing resources, networking resources, and/or other resources that would have otherwise been consumed by failing to cause 5G SA capable UEs 105 to select SUCI for authentication when provisioned with a 5G provisioning plan, or conversely to select IMSI when provisioned with a 4G provisioning plan during non-3GPP access, failing to uphold intended privacy standards of a 5G core network, adding complexity and inefficiency to network operations, failing to maintain privacy of subscriber identities, and/or the like.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

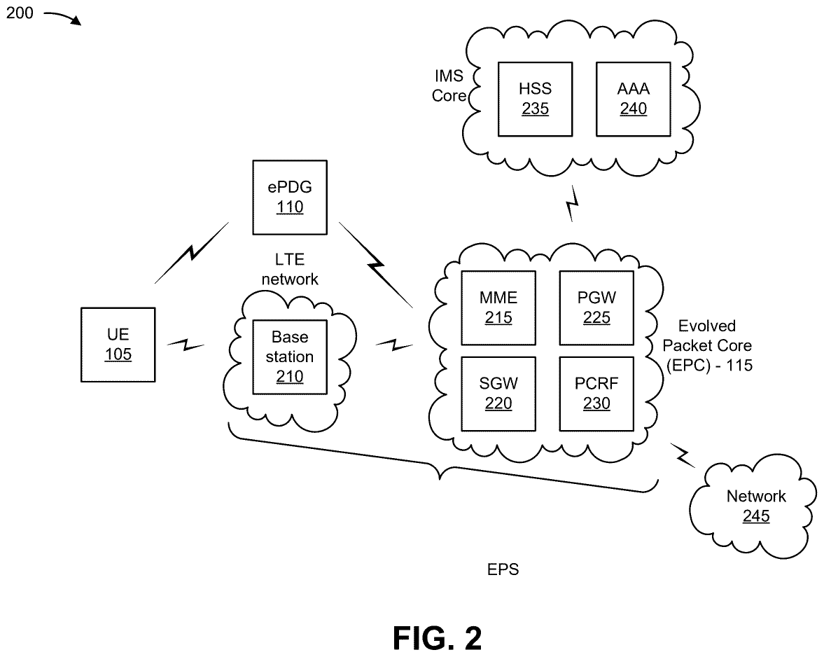

FIG. 2 is a diagram of an example environment 200 in which systems and/or methods, described herein, may be implemented. As shown in FIG. 2, the environment 200 may include the UE 105, the ePDG 110, a base station 210, a mobility management entity device (MME) 215, a serving gateway (SGW) 220, a packet data network gateway (PGW) 225, a policy and charging rules function (PCRF) 230, an HSS 235, an AAA 240, and a network 245. Devices of the environment 200 may interconnect via wired connections, wireless connections, or a combination of wired and wireless connections.

Some implementations are described herein as being performed within a long-term evolution (LTE) network for explanatory purposes. Some implementations may be performed within a network that is not an LTE network, such as a third generation (3G) network or a fifth generation (5G) network.

The environment 200 may include an evolved packet system (EPS) that includes an LTE network and/or an evolved packet core (EPC) (e.g., the 4G core network 115) that operate based on a 3GPP wireless communication standard. The LTE network may include a radio access network (RAN) that includes one or more base stations 210 that take the form of evolved Node Bs (eNBs) via which the UE 105 communicates with the EPC. The EPC may include the MME 215, the SGW 220, the PGW 225, and/or the PCRF 230 to enable the UE 105 to communicate with the network 245 and/or an Internet protocol (IP) multimedia subsystem (IMS) core. The IMS core may include the HSS 235 and/or the AAA 240, and may manage device registration and authentication, session initiation, and/or other operations associated with UEs 105. The HSS 235 and/or the AAA 240 may reside in the EPC and/or the IMS core. In some implementations, the 4G core network 115 may include the EPC and the IMS core.

The UE 105 includes one or more devices capable of receiving, generating, storing, processing, and/or providing information, such as information described herein. For example, the UE 105 may include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The ePDG 110 includes one or more devices capable of receiving, generating, storing, processing, and/or providing information, such as information described herein. For example, the ePDG 110 facilitates secure communication between the UE 105 and the 4G core network 115 (or the 5G core network 120) over untrusted non-3GPP access networks, such as Wi-Fi. The ePDG 110 may utilize a secure connection (e.g., an Internet protocol security (IPSec) tunnel) to provide secure communication between the UE 105 and the 4G core network 115 (or the 5G core network 120) over an untrusted non-3GPP access network. The ePDG 110 may handles mobility management for a UE 105 moving between different networks, ensuring session continuity and seamless handovers between Wi-Fi and cellular networks. The ePDG 110 acts as an intermediary between the non-3GPP access network and the 4G core network 115 (or the 5G core network 120). By creating secure IPsec tunnels, the ePDG prevents unauthorized access and protects user data from potential threats present in untrusted networks.

The base station 210 includes one or more devices capable of transferring traffic, such as audio, video, text, and/or other traffic, destined for and/or received from the UE 105. In some implementations, the base station 210 may include an eNB associated with the LTE network that receives traffic from and/or sends traffic to the network 245 via the SGW 220 and/or the PGW 225. Additionally, or alternatively, one or more base stations 210 may be associated with a RAN that is not associated with the LTE network. The base station 210 may send traffic to and/or receive traffic from the UE 105 via an air interface. In some implementations, the base station 210 may include a small cell base station, such as a base station of a microcell, a picocell, or a femtocell.

The MME 215 includes one or more devices, such as one or more server devices, capable of managing authentication, activation, deactivation, and/or mobility functions associated with the UE 105. In some implementations, the MME 215 may perform operations relating to authentication of the UE 105. Additionally, or alternatively, the MME 215 may facilitate the selection of a particular SGW 220 and/or a particular PGW 225 to provide traffic to and/or from the UE 105. The MME 215 may perform operations associated with handing off the UE 105 from a first base station 210 to a second base station 210 when the UE 105 is transitioning from a first cell associated with the first base station 210 to a second cell associated with the second base station 210. Additionally, or alternatively, the MME 215 may select another MME (not pictured), to which the UE 105 should be handed off (e.g., when the UE 105 moves out of range of the MME 215).

The SGW 220 includes one or more devices capable of routing packets. For example, the SGW 220 may include one or more data processing and/or traffic transfer devices, such as a gateway, a router, a modem, a switch, a firewall, a network interface card (NIC), a hub, a bridge, a server device, an optical add/drop multiplexer (OADM), or any other type of device that processes and/or transfers traffic. In some implementations, the SGW 220 may aggregate traffic received from one or more base stations 210 associated with the LTE network, and may send the aggregated traffic to the network 245 (e.g., via the PGW 225) and/or other network devices associated with the EPC and/or the IMS core. The SGW 220 may receive traffic from the network 245 and/or other network devices, and may send the received traffic to the UE 105 via the base station 210. Additionally, or alternatively, the SGW 220 may perform operations associated with handing off the UE 105 to and/or from an LTE network.

The PGW 225 includes one or more devices capable of providing connectivity for the UE 105 to external packet data networks (e.g., other than the depicted EPC and/or LTE network). For example, the PGW 225 may include one or more data processing and/or traffic transfer devices, such as a gateway, a router, a modem, a switch, a firewall, a NIC, a hub, a bridge, a server device, an OADM, or any other type of device that processes and/or transfers traffic. In some implementations, the PGW 225 may aggregate traffic received from one or more SGWs 220, and may send the aggregated traffic to the network 245. Additionally, or alternatively, the PGW 225 may receive traffic from the network 245, and may send the traffic to the UE 105 via the SGW 220 and the base station 210. The PGW 225 may record data usage information (e.g., byte usage), and may provide the data usage information to the AAA 240.

The PCRF 230 includes one or more devices, such as one or more server devices, capable of providing policy control decision and flow-based charging control functionalities. For example, the PCRF 230 may provide network control regarding service data flow detection, gating, and/or quality of service (QoS) and flow-based charging, among other examples. In some implementations, the PCRF 230 may determine how a certain service data flow is to be treated, and may ensure that user plane traffic mapping and treatment is in accordance with a user subscription profile.

The HSS 235 includes one or more devices, such as one or more server devices, capable of managing (e.g., receiving, generating, storing, processing, and/or providing) information associated with the UE 105. For example, the HSS 235 may manage subscription information associated with the UE 105, such as information that identifies a subscriber profile of a user associated with the UE 105, information that identifies services and/or applications that are accessible to the UE 105, location information associated with the UE 105, a network identifier (e.g., a network address) that identifies the UE 105, information that identifies a treatment of the UE 105 (e.g., quality of service information, a quantity of minutes allowed per time period, a quantity of data consumption allowed per time period, etc.), and/or similar information. The HSS 235 may provide this information to one or more other devices of the environment 200 to support the operations performed by those devices.

The AAA 240 includes one or more devices, such as one or more server devices, that perform authentication, authorization, and/or accounting operations for communication sessions associated with the UE 105. For example, the AAA 240 may perform authentication operations for the UE 105 and/or a user of the UE 105 (e.g., using one or more credentials), may control access, by the UE 105, to a service and/or an application (e.g., based on one or more restrictions, such as time-of-day restrictions, location restrictions, single or multiple access restrictions, read/write restrictions, etc.), may track resources consumed by the UE 105 (e.g., a quantity of voice minutes consumed, a quantity of data consumed, etc.), and/or may perform similar operations.

The network 245 includes one or more wired and/or wireless networks. For example, the network 245 may include a cellular network (e.g., a 5G network, an LTE network, a 3G network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

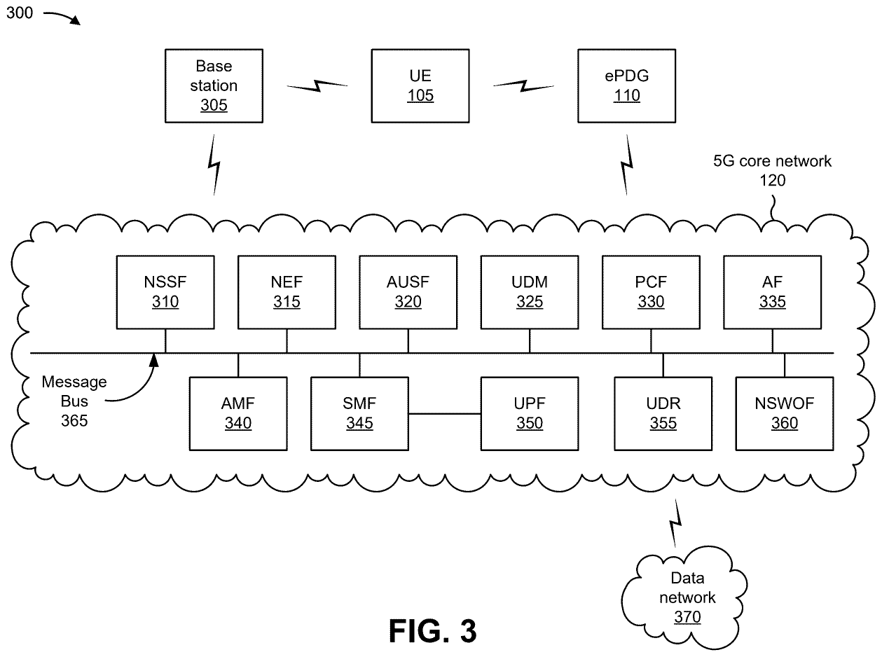

FIG. 3 is a diagram of an example environment 300 in which systems and/or methods described herein may be implemented. As shown in FIG. 3, the example environment 300 may include the UE 105, the ePDG 110, the 5G core network 120, a base station 305, and a data network 370. Devices and/or networks of the example environment 300 may interconnect via wired connections, wireless connections, or a combination of wired and wireless connections.

The UE 105 and the ePDG 110 are described above in connection with FIG. 2.

In some implementations, the 5G core network 120 may include an example functional architecture in which systems and/or methods described herein may be implemented. For example, the 5G core network 120 may include an example architecture of a 5G next generation (NG) core network included in a 5G wireless telecommunications system. While the example architecture of the 5G core network 120 shown in FIG. 3 may be an example of a service-based architecture, in some implementations, the 5G core network 120 may be implemented as a reference-point architecture and/or a 4G core network, among other examples.

As shown in FIG. 3, the 5G core network 120 may include a number of functional elements. The functional elements may include, for example, a network slice selection function (NSSF) 310, a network exposure function (NEF) 315, an AUSF 320, a UDM component 325, a policy control function (PCF) 330, an application function (AF) 335, an access and mobility management function (AMF) 340, a session management function (SMF) 345, a user plane function (UPF) 350, a UDR 355, and/or an NSWOF 360. These functional elements may be communicatively connected via a message bus 365. Each of the functional elements shown in FIG. 3 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The base station 305 may support, for example, a cellular radio access technology (RAT). The base station 305 may include one or more base stations (e.g., base transceiver stations, radio base stations, node Bs, gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 105. The base station 305 may transfer traffic between UE 105 (e.g., using a cellular RAT), one or more base stations (e.g., using a wireless interface or a backhaul interface, such as a wired backhaul interface), and/or the 5G core network 120. The base station 305 may provide one or more cells that cover geographic areas.

In some implementations, the base station 305 may perform scheduling and/or resource management for the UE 105 covered by the base station 305 (e.g., the UE 105 covered by a cell provided by the base station 305). In some implementations, the base station 305 may be controlled or coordinated by a network controller, which may perform load balancing, network-level configuration, and/or other operations. The network controller may communicate with the base station 305 via a wireless or wireline backhaul. In some implementations, the base station 305 may include a network controller, a self-organizing network (SON) module or component, or a similar module or component. In other words, the base station 305 may perform network control, scheduling, and/or network management functions (e.g., for uplink, downlink, and/or sidelink communications of the UE 105 covered by the base station 305).

The NSSF 310 includes one or more devices that select network slice instances for the UE 105. By providing network slicing, the NSSF 310 allows an operator to deploy multiple substantially independent end-to-end networks potentially with the same infrastructure. In some implementations, each slice may be customized for different services.

The NEF 315 includes one or more devices that support exposure of capabilities and/or events in the wireless telecommunications system to help other entities in the wireless telecommunications system discover network services.

The AUSF 320 includes one or more devices that act as an authentication server and support the process of authenticating the UE 105 in the wireless telecommunications system.

The UDM 325 includes one or more devices that store user data and profiles in the wireless telecommunications system. The UDM 325 may be used for fixed access and/or mobile access in the 5G core network 120.

The PCF 330 includes one or more devices that provide a policy framework that incorporates network slicing, roaming, packet processing, and/or mobility management, among other examples.

The AF 335 includes one or more devices that support application influence on traffic routing, access to the NEF 315, and/or policy control, among other examples.

The AMF 340 includes one or more devices that act as a termination point for non-access stratum (NAS) signaling and/or mobility management, among other examples.

The SMF 345 includes one or more devices that support the establishment, modification, and release of communication sessions in the wireless telecommunications system. For example, the SMF 345 may configure traffic steering policies at the UPF 350 and/or may enforce user equipment IP address allocation and policies, among other examples.

The UPF 350 includes one or more devices that serve as an anchor point for intraRAT and/or interRAT mobility. The UPF 350 may apply rules to packets, such as rules pertaining to packet routing, traffic reporting, and/or handling user plane quality of service (QoS), among other examples.

The UDR 355 includes one or more devices that store and manage data relevant to subscribers and network functions, such as user subscription information, policy data, and session context. The UDR 355 acts as a unified and centralized database that various network functions can access. The UDM 325 may retrieve subscription data from the UDR 355 during user authentication, mobility, and access management procedures. The PCF 330 may refer to the UDR 355 to get policy rules when enforcing policies for data sessions. The SMF 345 may access the UDR 355 for session-related data to manage and maintain user sessions effectively.

The NSWOF 360 includes one or more devices that enable the UE 105 to shift a portion of data traffic from a cellular network to a Wi-Fi network without requiring a seamless handover. The NSWOF 360 does not prioritize maintaining uninterrupted service during the transition between the networks, which means that users may experience brief interruptions or service disruptions. The NSWOF 360 may manage and oversee the offloading process for the UE 105 by communicating with both the UE 105 and network elements. The NSWOF 360 may evaluate detected Wi-Fi networks based on predefined criteria, such as signal strength, throughput capability, and security requirements. When a suitable Wi-Fi network is identified, the NSWOF 360 may initiate offloading. By offloading certain types of data traffic to Wi-Fi networks, the NSWOF 360 helps reduce loads on cellular networks, thus enhancing overall efficiency and user experience.

The message bus 365 represents a communication structure for communication among the functional elements. In other words, the message bus 365 may permit communication between two or more functional elements.

The data network 370 includes one or more wired and/or wireless data networks. For example, the data network 370 may include an IMS, a PLMN, a LAN, a WAN, an MAN, a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the example environment 300 may perform one or more functions described as being performed by another set of devices of the example environment 300.

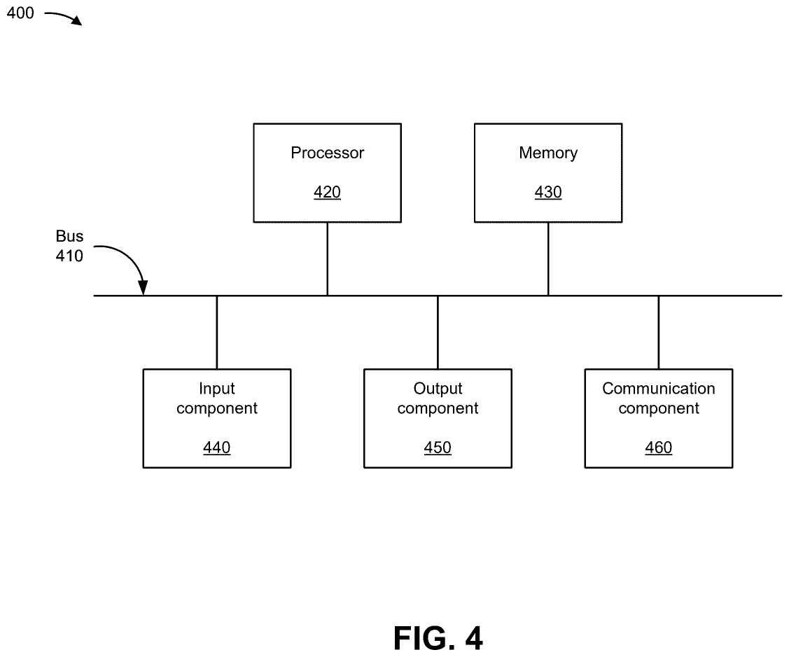

FIG. 4 is a diagram of example components of a device 400, which may correspond to the UE 105, the ePDG 110, the base station 210, the MME 215, the SGW 220, the PGW 225, the PCRF 230, the HSS 235, the AAA 240, the NSSF 310, the NEF 315, the AUSF 320, the UDM 325, the PCF 330, the AF 335, the AMF 340, the SMF 345, the UPF 350, the UDR 355, and/or the NSWOF 360. In some implementations, the UE 105, the ePDG 110, the base station 210, the MME 215, the SGW 220, the PGW 225, the PCRF 230, the HSS 235, the AAA 240, the NSSF 310, the NEF 315, the AUSF 320, the UDM 325, the PCF 330, the AF 335, the AMF 340, the SMF 345, the UPF 350, the UDR 355, and/or the NSWOF 360 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection).

The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

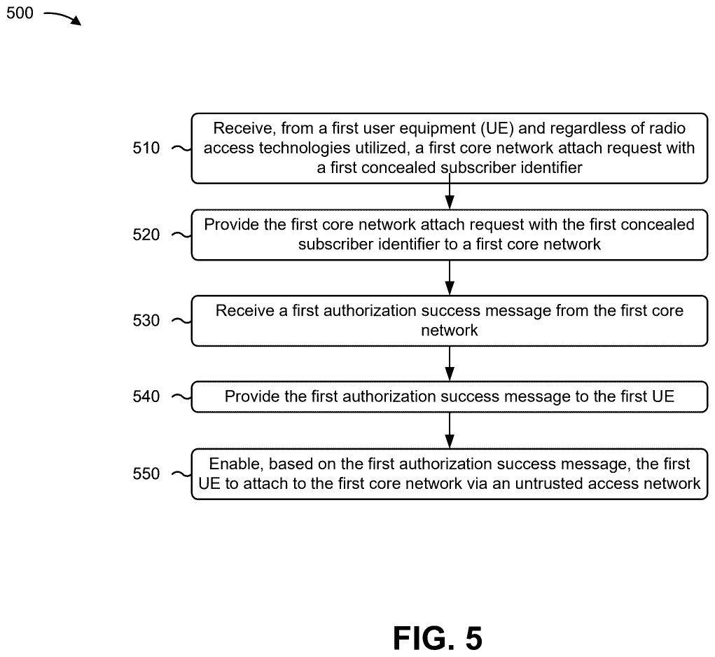

FIG. 5 is a flowchart of an example process 500 for selecting an identifier for a 5G SA capable device. In some implementations, one or more process blocks of FIG. 5 may be performed by a device (e.g., the ePDG 110). In some implementations, one or more process blocks of FIG. 5 may be performed by another device or a group of devices separate from or including the device, such as a UE (e.g., the UE 105). Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving, from a first UE and regardless of RATs utilized, a first core network attach request with a first concealed subscriber identifier (block 510). For example, the device may receive, from a first UE and regardless of RATs utilized, a first core network attach request with a first concealed subscriber identifier, as described above. In some implementations, the device is an ePDG and the first UE is a standalone capable device.

As further shown in FIG. 5, process 500 may include providing the first core network attach request with the first concealed subscriber identifier to a first core network (block 520). For example, the device may provide the first core network attach request with the first concealed subscriber identifier to a first core network, as described above. In some implementations, the first concealed subscriber identifier is a SUCI associated with a subscriber of the first UE.

As further shown in FIG. 5, process 500 may include receiving a first authorization success message from the first core network (block 530). For example, the device may receive a first authorization success message from the first core network, as described above. In some implementations, the first authorization success message is received from one of an NSWOF, a UDM component, a UDR, or an AUSF of the first core network.

As further shown in FIG. 5, process 500 may include providing the first authorization success message to the first UE (block 540). For example, the device may provide the first authorization success message to the first UE, as described above.

As further shown in FIG. 5, process 500 may include enabling, based on the first authorization success message, the first UE to attach to the first core network via an untrusted access network (block 550). For example, the device may enable, based on the first authorization success message, the first UE to attach to the first core network via an untrusted access network, as described above.

In some implementations, process 500 includes receiving, from a second UE, a second core network attach request with a second concealed subscriber identifier; providing the second core network attach request with the second concealed subscriber identifier to the first core network; receiving, from the first core network, an authorization reject message with an error code indicating that the second UE is not authorized to attach to the first core network; storing the error code; and providing the authorization reject message with the error code to the second UE. In some implementations, process 500 includes utilizing the stored error code in a subsequent attach attempt by the second UE. In some implementations, process 500 includes receiving, from the second UE, a third core network attach request with an unconcealed subscriber identifier; providing the third core network attach request with the unconcealed subscriber identifier to a second core network; receiving a second authorization success message from the second core network; providing the second authorization success message to the second UE; and enabling, based on the second authorization success message, the second UE to attach to the second core network via the untrusted access network. In some implementations, the unconcealed subscriber identifier is an IMSI associated with a subscriber of the second UE.

In some implementations, process 500 includes receiving, from a second UE, a flag indicating that the second UE is provisioned for the first core network; providing, to the first core network and based on the flag, a second core network attach request with a second concealed subscriber identifier; receiving a second authorization success message from the first core network; providing the second authorization success message to the second UE; and enabling, based on the second authorization success message, the second UE to attach to the first core network via the untrusted access network. In some implementations, the second concealed subscriber identifier is a SUCI associated with a subscriber of the second UE.

In some implementations, process 500 includes receiving, from a second UE, a flag indicating that the second UE is provisioned for a second core network; providing, to the second core network and based on the flag, a second core network attach request with an unconcealed subscriber identifier; receiving a second authorization success message from the second core network; providing the second authorization success message to the second UE; and enabling, based on the second authorization success message, the second UE to attach to the second core network via the untrusted access network. In some implementations, the unconcealed subscriber identifier is an IMSI associated with a subscriber of the second UE. In some implementations, the first core network is a 5G core network and the second core network is a 4G core network.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more. ” Further, as used herein, the article “the” is intended to include one or more items referenced in connection with the article “the” and may be used interchangeably with “the one or more. ” Furthermore, as used herein, the term “set” is intended to include one or more items (e.g., related items, unrelated items, or a combination of related and unrelated items), and may be used interchangeably with “one or more. ” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either”or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed IS:

1. A method, comprising:
receiving, by a device, from a first user equipment (UE), and regardless of radio access technologies utilized, a first core network attach request with a first concealed subscriber identifier;
providing, by the device, the first core network attach request with the first concealed subscriber identifier to a first core network;
receiving, by the device, a first authorization success message from the first core network;
providing, by the device, the first authorization success message to the first UE; and
enabling, by the device and based on the first authorization success message, the first UE to attach to the first core network via an untrusted access network.

2. The method of claim 1, wherein the first concealed subscriber identifier is a subscriber concealed identifier associated with a subscriber of the first UE.

3. The method of claim 1, further comprising:
receiving, from a second UE, a second core network attach request with a second concealed subscriber identifier;
providing the second core network attach request with the second concealed subscriber identifier to the first core network;
receiving, from the first core network, an authorization reject message with an error code indicating that the second UE is not authorized to attach to the first core network;
storing the error code; and
providing the authorization reject message with the error code to the second UE.

4. The method of claim 3, further comprising:
utilizing the stored error code in a subsequent attach attempt by the second UE.

5. The method of claim 3, further comprising:
receiving, from the second UE, a third core network attach request with an unconcealed subscriber identifier;
providing the third core network attach request with the unconcealed subscriber identifier to a second core network;
receiving a second authorization success message from the second core network;
providing the second authorization success message to the second UE; and
enabling, based on the second authorization success message, the second UE to attach to the
second core network via the untrusted access network.

6. The method of claim 5, wherein the unconcealed subscriber identifier is an international mobile subscriber identity associated with a subscriber of the second UE.

7. The method of claim 1, wherein the device is an evolved packet data gateway and the first UE is a standalone capable device.

8. A device, comprising:
one or more processors configured to:
receive, from a first user equipment (UE) and regardless of radio access technologies utilized, a first core network attach request with a first concealed subscriber identifier,
wherein the first concealed subscriber identifier is a subscriber concealed identifier associated with a subscriber of the first UE;
provide the first core network attach request with the first concealed subscriber identifier to a first core network;
receive a first authorization success message from the first core network;
provide the first authorization success message to the first UE; and
enable, based on the first authorization success message, the first UE to attach to the first core network via an untrusted access network.

9. The device of claim 8, wherein the one or more processors are further configured to:
receive, from a second UE, a flag indicating that the second UE is provisioned for the first core network;
provide, to the first core network and based on the flag, a second core network attach request with a second concealed subscriber identifier;
receive a second authorization success message from the first core network;
provide the second authorization success message to the second UE; and
enable, based on the second authorization success message, the second UE to attach to the first core network via the untrusted access network.

10. The device of claim 9, wherein the second concealed subscriber identifier is a subscriber concealed identifier associated with a subscriber of the second UE.

11. The device of claim 8, wherein the one or more processors are further configured to:
receive, from a second UE, a flag indicating that the second UE is provisioned for a second core network;
provide, to the second core network and based on the flag, a second core network attach request with an unconcealed subscriber identifier;
receive a second authorization success message from the second core network;
provide the second authorization success message to the second UE; and
enable, based on the second authorization success message, the second UE to attach to the second core network via the untrusted access network.

12. The device of claim 11, wherein the unconcealed subscriber identifier is an international mobile subscriber identity associated with a subscriber of the second UE.

13. The device of claim 11, wherein the first core network is a fifth generation core network and the second core network is a fourth generation core network.

14. The device of claim 8, wherein the first authorization success message is received from one of a non-seamless wireless local area network offload function, a unified data management component, a unified data repository, or an authentication server function of the first core network.

15. A non-transitory computer-readable medium storing a set of instructions, the set of instructions comprising:
one or more instructions that, when executed by one or more processors of a device, cause the device to:
receive, from a first user equipment (UE) and regardless of radio access technologies utilized, a first core network attach request with a first concealed subscriber identifier;
provide the first core network attach request with the first concealed subscriber identifier to a first core network;
receive a first authorization success message from the first core network,
wherein the first authorization success message is received from one of a non-seamless wireless local area network offload function, a unified data management component, a unified data repository, or an authentication server function of the first core network;
provide the first authorization success message to the first UE; and
enable, based on the first authorization success message, the first UE to attach to the first core network via an untrusted access network.

16. The non-transitory computer-readable medium of claim 15, wherein the one or more instructions further cause the device to:
receive, from a second UE, a second core network attach request with a second concealed subscriber identifier;
provide the second core network attach request with the second concealed subscriber identifier to the first core network;
receive, from the first core network, an authorization reject message with an error code indicating that the second UE is not authorized to attach to the first core network;
store the error code;
provide the authorization reject message with the error code to the second UE; and
utilize the stored error code in a subsequent attach attempt by the second UE.

17. The non-transitory computer-readable medium of claim 16, wherein the one or more instructions further cause the device to:
receive, from the second UE, a third core network attach request with an unconcealed subscriber identifier;
provide the third core network attach request with the unconcealed subscriber identifier to a second core network;
receive a second authorization success message from the second core network;
provide the second authorization success message to the second UE; and
enable, based on the second authorization success message, the second UE to attach to the second core network via the untrusted access network.

18. The non-transitory computer-readable medium of claim 15, wherein the one or more instructions further cause the device to:
receive, from a second UE, a flag indicating that the second UE is provisioned for the first core network;
provide, to the first core network and based on the flag, a second core network attach request with a second concealed subscriber identifier;
receive a second authorization success message from the first core network;
provide the second authorization success message to the second UE; and
enable, based on the second authorization success message, the second UE to attach to the first core network via the untrusted access network.

19. The non-transitory computer-readable medium of claim 15, wherein the one or more instructions further cause the device to:
receive, from a second UE, a flag indicating that the second UE is provisioned for a second core network;
provide, to the second core network and based on the flag, a second core network attach request with an unconcealed subscriber identifier;
receive a second authorization success message from the second core network;
provide the second authorization success message to the second UE; and
enable, based on the second authorization success message, the second UE to attach to the second core network via the untrusted access network.

20. The non-transitory computer-readable medium of claim 19, wherein the unconcealed subscriber identifier is an international mobile subscriber identity associated with a subscriber of the second UE.
